(19) United States
(12) Patent Application Publication
(10) Pub. No.: US 2020/0166354 A1
(43) Pub. Date: May 28, 2020

(54) OPERATION ASSISTANCE DEVICE, ON-VEHICLE DEVICE, OPERATION ASSISTANCE SYSTEM, OPERATION ASSISTANCE METHOD, AND OPERATION ASSISTANCE PROGRAM

(71) Applicant: TOYOTA JIDOSHA KABUSHIKI KAISHA, Toyota-shi (JP)

(72) Inventors: Koichi Ikemoto, Nagoya-shi (JP); Keiji Yamashita, Nisshin-shi (JP); Koji Taguchi, Sagamihara-shi (JP); Shin Sakurada, Toyota-shi (JP); Tomoyuki Kuriyama, Hadano-shi (JP)

(73) Assignee: TOYOTA JIDOSHA KABUSHIKI KAISHA, Toyota-shi (JP)

(21) Appl. No.: 16/654,426

(22) Filed: Oct. 16, 2019

(30) Foreign Application Priority Data
Nov. 26, 2018 (JP) 2018-220361

(51) Int. Cl. G01C 21/34; G05D 1/00; G05D 1/02; G01C 21/36

(52) U.S. Cl. CPC G01C 21/3438; G01C 21/3605; G05D 1/0212; G05D 1/0088

(57) ABSTRACT

An operation assistance device includes a communication unit configured to communicate with a portable terminal of a user who uses a vehicle and an on-vehicle device, an acquisition unit configure to acquire a kind of the user from the portable terminal through the communication unit, a getting on and off position setting unit configured to set a getting on position or a getting off position of the user, and a getting on and off position transmission unit configure to transmit the set getting on position or the set getting off position to the on-vehicle device through the communication unit. A stop allowable area for getting on and off is set in advance for each kind of the user. The getting on and off position setting unit sets the getting on position or the getting off position in the stop allowable area corresponding to the acquired kind of the user.

The disclosure of Japanese Patent Application No. 2018-220361 filed on Nov. 26, 2018 including the specification, drawings and abstract is incorporated herein by reference in its entirety.

### BACKGROUND

### 1. Technical Field

The present disclosure relates to an operation assistance device, an on-vehicle device, an operation assistance system, an operation assistance method, and an operation assistance program that assist an operation of a vehicle.

### 2. Description of Related Art

In recent years, an autonomous driving technique has been developed toward realizing mobility services such as a taxi, a bus, and ridesharing using an autonomous driving vehicle in which driving is performed by an autonomous control. In such a mobility service, a plurality of users who intends to move to a destination in the same direction gets on one autonomous driving vehicle together and head toward the destination (for example, refer to Japanese Unexamined Patent Application Publication No. 2017-182137 (JP 2017-182137 A)). For example, in an autonomous driving control system described in JP 2017-182137 A, an operation route including a getting on and off position designated by the user is generated according to a use request, and the vehicle is operated by the autonomous control according to the operation route.

Further, a welfare vehicle configured to support a wheelchair user or the like to get on and off the vehicle has been developed (for example, refer to Japanese Unexamined Patent Application Publication No. 2002-204814 (JP 2002-204814 A)). For example, in a wheelchair loading and unloading lift device of the vehicle described in JP 2002-204814 A, when the wheelchair user or the like gets on and off the vehicle, a deck capable of moving up and down a wheelchair in a state where the wheelchair is mounted and slopes for the wheelchair formed by bridging wheel guide rails to the ground are used.

### SUMMARY

Incidentally, in such an autonomous driving technique, the getting on and off position designated by the user may not always be appropriate for the user to get on and off. For example, the above welfare vehicle needs a large space for getting on and off the wheelchair, such as a space for extending the deck out of the vehicle and a space for forming the slopes fire the wheelchair. Therefore, there may a case where there is not enough space for getting on and off the wheelchair depending on the getting on and off position designated by the user and thus the wheelchair user or the like cannot safely get on and off.

Further, for example, when a child alone uses such a mobility service, it may be preferable to get the child on and off at a place where the number of car passes is relatively smaller than the designated getting on and off position from a viewpoint of restraining a traffic accident or the like.

In view of the above problems, an object of the present disclosure is to restrain a user from getting on and off at an inappropriate place.

The gist of the present disclosure is as follows.

(1) A first aspect of the disclosure relates to an operation assistance device that assists an operation of a vehicle. The operation assistance device includes a communication unit configured to communicate with a portable terminal of a user who uses the vehicle and an on-vehicle device mounted on the vehicle, an acquisition unit configured to acquire a kind of the user from the portable terminal through the communication unit, a getting on and off position setting unit configured to set a getting on position or a getting off position of the user, and a getting on and off position transmission unit configured to transmit the set getting on position or the set getting off position to the on-vehicle device through the communication unit. A stop allowable area for getting on and off is set in advance for each kind of the user. The getting on and off position setting unit sets the getting on position or the getting off position in the stop allowable area corresponding to the acquired kind of the user.

(2) In the operation assistance device according to first aspect, the on-vehicle device may include an autonomous driving controller configured to cause the vehicle to perform autonomous traveling. The autonomous driving controller may be configured to cause the vehicle to travel toward the getting on position or the getting off position transmitted through the getting on and off position transmission unit.

(3) The operation assistance device according to the first aspect may further include a vehicle search unit configured to search for a vehicle whose operation plan is adjustable such that the vehicle stops at the set getting on position in a state where another passenger gets on when the kind of the user is a specific kind, and an allocated vehicle selection unit configured to select a vehicle to be allocated to the getting on position from among the searched vehicles. The getting on and off position transmission unit may transmit the set getting on position or the set getting off position to an on-vehicle device of the selected vehicle through the communication unit.

(4) The operation assistance device according to the first aspect, the acquisition unit may acquire support availability information indicating whether or not supporting another user to get on the vehicle together is available from the portable terminal through the communication unit. The vehicle search unit may search for a vehicle whose operation plan is adjustable such, that the vehicle stops at the set getting on position in a state where another passenger who accepts the supporting another user gets on based on the acquired support availability information.

(5) A second aspect of the disclosure relates to an on-vehicle device mounted on a vehicle. The on-vehicle device includes a communication unit configured to communicate with a portable terminal of a user who uses the vehicle, an acquisition unit configured to acquire a kind of the user from the portable terminal through the communication unit, and a getting on and off position setting unit configured to set a getting on position or a getting off position of the user. A stop allowable area for getting on and off is set in advance for each kind of the user. The getting on and off position setting unit sets the getting on position or the getting off position in the stop allowable area corresponding to the acquired kind of the user.

(6) The on-vehicle device according to the second aspect may further include an autonomous driving controller configured to cause the vehicle to perform autonomous traveling. The autonomous driving controller may be configured to cause the vehicle to travel toward the set getting on position or the set getting off position.

(7) A third aspect of the disclosure relates to an operation assistance system that assists an operation of a vehicle. The operation assistance system includes a portable terminal of a user who uses the vehicle, an on-vehicle device mounted on the vehicle and configured to communicate with the portable terminal, and a server configured to communicate with the portable terminal and the on-vehicle device. The server includes an acquisition unit configured to acquire a kind of the user from the portable terminal, a getting on and off position setting unit configured to set a getting on position or a getting off position of the user, and a getting on and off position transmission unit configured to transmit the set getting on position or the set getting off position to the on-vehicle device. A stop allowable area for getting on and off is set in advance for each kind of the user. The getting on and off position Setting unit sets the getting on position or the getting off position in the stop allowable area corresponding to the acquired kind of the user.

(8) A fourth aspect of the disclosure relates to an operation assistance system that assists an operation of a vehicle. The operation assistance system includes a portable terminal of a user who uses the vehicle, and an on-vehicle device mounted on the vehicle and configured to communicate with the portable terminal. The on-vehicle device includes an acquisition unit configured to acquire a kind of the user from the portable terminal, and a getting on and off position setting unit configured to set a getting on position or a getting off position of the user. A stop allowable area for getting on and off is set in advance for each kind of the user. The getting on and off position setting unit sets the getting on position or the getting off position in the stop allowable area corresponding to the acquired kind of the user.

(9) A fifth aspect of the disclosure relates to an operation assistance method that assists an operation of a vehicle. The operation assistance method includes a step of acquiring a kind of the user from a portable terminal of a user who uses the vehicle, and a step of setting a getting on position or a getting off position of the user. A stop allowable area for getting on and off is set in advance for each kind of the user. The step of setting sets the getting on position or the getting off position in the stop allowable area corresponding to the acquired kind of the user.

(10) A sixth aspect of the disclosure relates to an operation assistance program that assists an operation of a vehicle. The operation assistance program causes a processor to execute a step of acquiring a kind of the user from a portable terminal of a user who uses the vehicle, and a step of setting, a getting on position or a getting off position of the user. A stop allowable area for getting on and off is set in advance for each kind of the user. The step of setting sets the getting on position or the getting off position in the stop allowable area corresponding to the acquired kind of the user.

According to the present disclosure, it is possible to restrain the user from getting on and off at an inappropriate place.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a diagram showing an example of a configuration of a passenger transportation system according to a first embodiment;

FIG. 2 is a schematic configuration diagram of a vehicle according to the first embodiment;

FIG. 3 is a schematic configuration diagram of a server according to the first embodiment;

FIG. 4 is a schematic configuration diagram of a portable terminal according to the first embodiment:

FIG. 5 is a sequence diagram showing an example of passenger transportation processing in the passenger transportation system according, to the first embodiment;

FIG. 6 is a flowchart showing a control routine of operation assistance processing in an operation assistance device according to the first embodiment;

FIG. 7 is a schematic configuration diagram of a server according to a second embodiment;

FIG. 8 is a flowchart showing a control routine of operation assistance processing in an, operation assistance device according to the second embodiment;

FIG. 9 is a schematic configuration diagram of an on-vehicle device of a vehicle according to the second embodiment;

FIG. 10 is a sequence diagram showing an example of passenger transportation processing: in a passenger transportation system according to a third embodiment;

FIG. 11 is a flowchart showing a control routine of the operation assistance processing in the operation assistance device according to the third embodiment; and

FIG. 12 is a schematic view of a configuration of an on-vehicle device of a vehicle according to a fourth embodiment.

### DETAILED DESCRIPTION OF EMBODIMENTS

Hereinafter, embodiments of the present disclosure will be described it detail with reference to drawings. In the following description, the same reference numeral is assigned to a similar component.

### First Embodiment

Overall Configuration of Passenger Transportation System

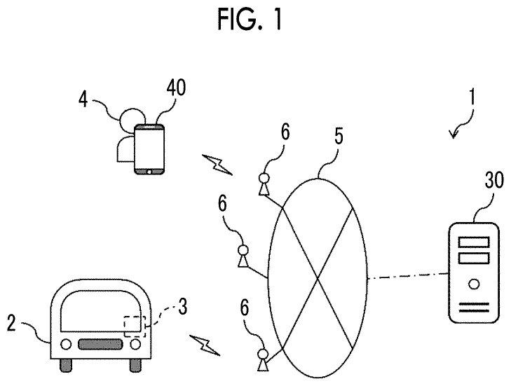

FIG. 1 is a diagram showing an example of a configuration of a passenger transportation system 1 according to the embodiment. The passenger transportation system 1 provides mobility services such as a taxi, a bus, and ridesharing. As shown in FIG. 1, the passenger transportation system I according to the embodiment includes an on-vehicle device 3 mounted on a vehicle 2, a server 30, and a portable terminal 40.

In the embodiment, the vehicle 2 an autonomous driving vehicle that provides the mobility services such as the taxi, the bus, and the ridesharing. In particular, in the embodiment, the vehicle 2 is an unmanned autonomous driving vehicle in which there is no occupant such as a driver. The server 30 is connected to a network 5 through, for example, a gateway (not shown). Further, the on-vehicle device 3 of the vehicle 2 and the portable terminal 40 are connected to the network 5 through, for example, a wireless base station 6.

Overall Configuration of Vehicle

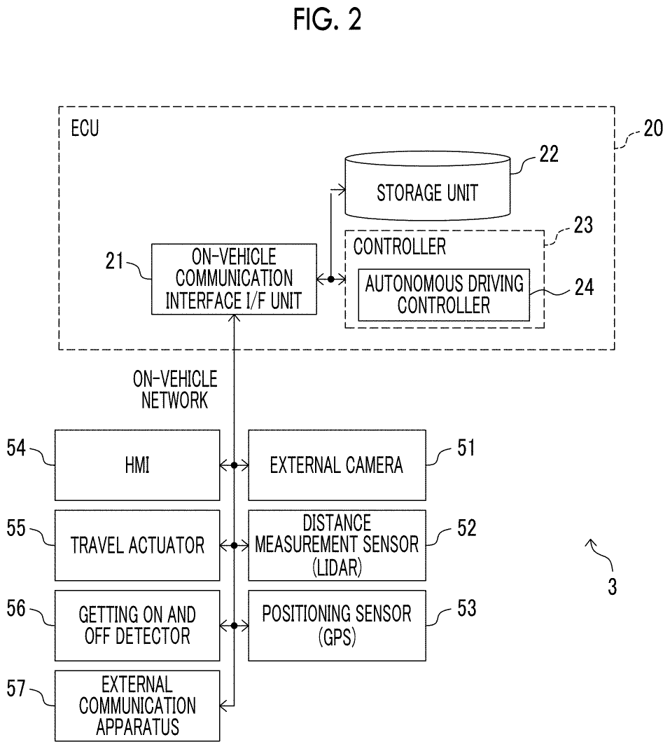

FIG. 2 is a schematic configuration diagram of the on-vehicle device 3 of the vehicle 2 according to the embodiment. As shown in FIG. 2, the on-vehicle devices 3 of the vehicle 2 includes an electronic control unit (ECU) 20, an external camera 51, a distance measurement sensor 52, a positioning sensor 53, a human machine interface (HMI) 54, a travel actuator 55, a getting on and off detector 56, and an external communication apparatus 57, which are connected to one another through an on-vehicle network. The on-vehicle network is, for example, a network conforming to a controller area network (CAN) standard.

The ECU 20 includes an on-vehicle communication interface (I/F) unit 21, a storage unit 22, and a controller 23, which are connected to one another through signal lines. The on-vehicle communication I/F unit 21 is a communication I/F circuit for the ECU 20 to communicate with other on-vehicle apparatuses of the vehicle 2 through the on-vehicle network.

The storage unit 22 can include, for example, a read only memory (ROM) or a random access memory (RAM). The storage unit 22 stores various programs used for pieces of processing by the controller 23 and various pieces of data (for example, various parameters and various threshold values).

The controller 23 can be, for example, a processor having a CPU and peripheral circuits thereof. The controller 23 executes various programs stored in the storage unit 22 and thus can execute various controls of the vehicle 2.

Further, the controller 23 includes a plurality of functional modules implemented by the program executed on the processor of the controller 23. As shown in FIG. 2, in the embodiment, the controller 23 includes an autonomous driving controller 24 that constitutes a part of the passenger transportation system 1 as the functional module.

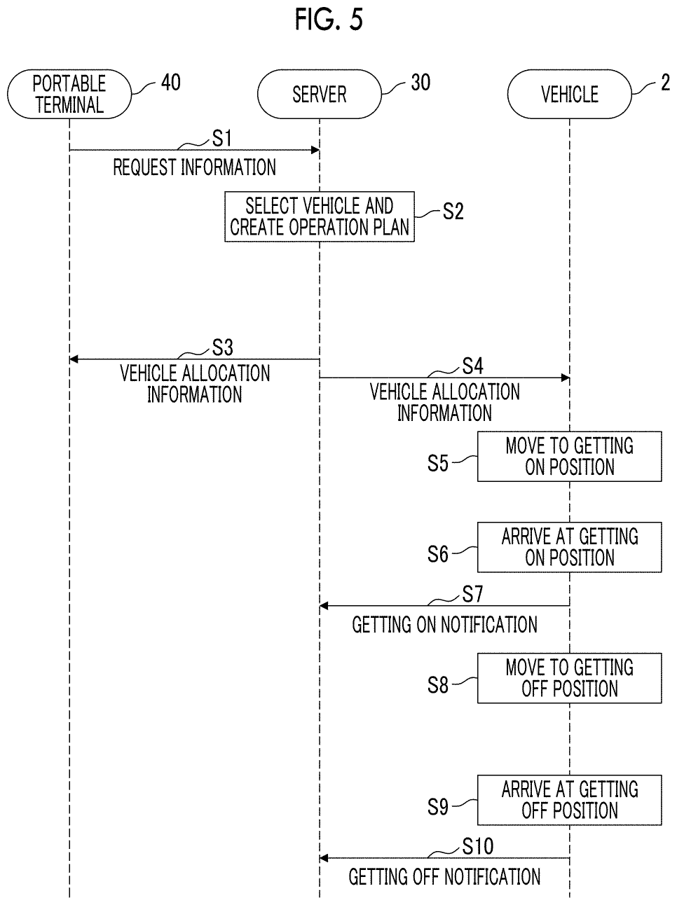

The autonomous driving controller 24 outputs a control signal for autonomously controlling the driving of the vehicle 2 based on signals output from the external camera 51, the distance measurement sensor 52, and the positioning sensor 53, which are described below, and a traveling route of the vehicle 2. The autonomous driving controller 24 executes processing related to the vehicle 2 among pieces of passenger transportation processing related to the mobility service described below with reference to FIG. 5.

The external camera 51 images and outputs a video around the vehicle 2. The video imaged by the external camera 51 is used for autonomously controlling the driving of the vehicle 2 by the autonomous driving controller 24. The external camera 51 is disposed near a windshield of the vehicle 2, for example, with an imaging surface of the camera toward the outside of the vehicle such that an object and a person around the vehicle 2 are clearly imaged.

The distance measurement sensor 52 measures and outputs a distance to an object in front of the vehicle 2 for each orientation. Distance information measured by the distance measurement sensor 52 is used for autonomously controlling the driving, of the vehicle 2 by the autonomous driving controller 24. The distance measurement sensor 52 is, for example, a light detection and ranging (LIDAR) installed in the vehicle 2.

The positioning sensor 53 generates position information indicating a current location of the vehicle 2 and outputs the position information to the ECU 20. The position information generated by the positioning sensor 53 is used for autonomously controlling the driving of the vehicle 2 by the autonomous driving controller 24 and is transmitted to the server 30 through the network 5 such that the server 30 can grasp the current location of the vehicle 2. The positioning sensor 53 is, for example, a global positioning system (GPS) of a car navigation system installed in the vehicle 2.

The HMI 54 is an interface for inputting and outputting information between a user 4 and the ECU 20. The HMI 54 includes, for example, a display for displaying information, a speaker for generating a sound, an operation button or a touch screen for a passenger to perform an input operation, and a microphone for receiving a voice of the passenger. The HMI 54 is provided, for example, for each seat of the vehicle 2.

The travel actuator 55 is a device for executing a traveling control of the vehicle 2. The travel actuator 55 controls driving force of the vehicle 2, braking force applied to the vehicle 2, and a steering action of the vehicle 2 in response to the control signal output from the autonomous driving controller 24.

When getting on or off of the user 4 is detected, the getting on and off detector 56 outputs a detection signal of the getting on or off to the ECU 20. The getting on and off detector 56 performs, for example, short-range wireless communication with the portable terminal 40 of the user 4 and thus can detect the getting on or off of the user 4.

The external communication apparatus 57 is an on-vehicle terminal having a wireless communication function. The external communication apparatus 57 is, for example, an on-vehicle navigation system, a data communication module (DCM), or a fifth generation (5G) communication apparatus. The external communication apparatus 57 is connected to the network 5 through the wireless base station 6.

Configuration of Server

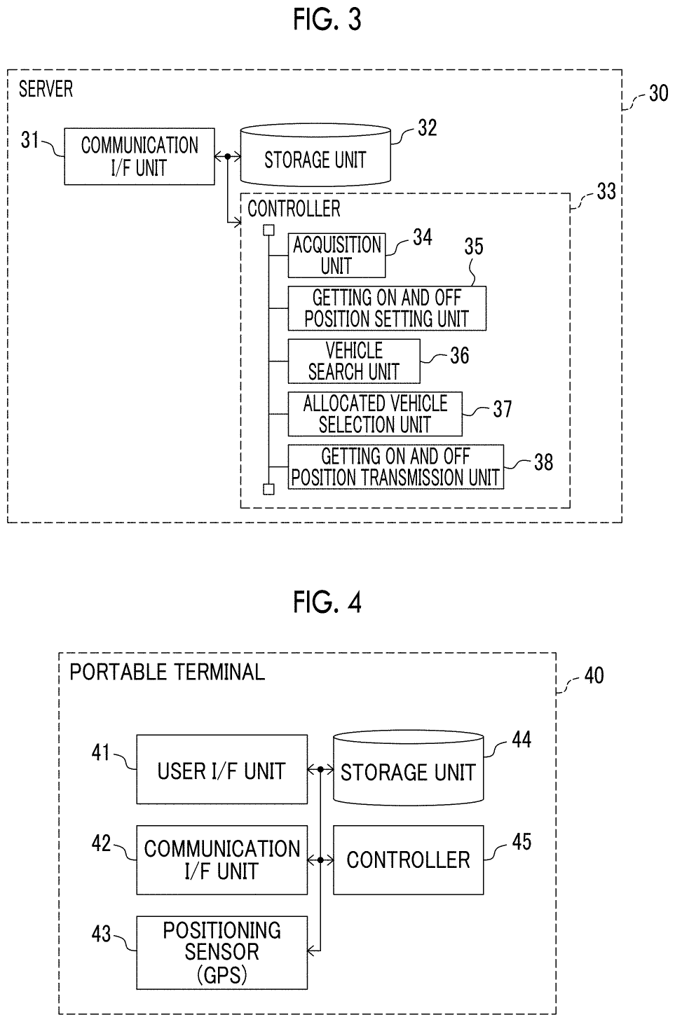

FIG. 3 is a schematic configuration diagram of the server 30 according to the embodiment. As shown in FIG. 3, the server 30 includes a communication I/F unit 31, a storage unit 32, and a controller 33, which are connected to one other through signal lines. The server 30 is an example of an operation assistance device according to the embodiment.

The communication I/F unit 31 is an example of the communication unit and is a communication I/F circuit for connecting the server 30 to the network 5. The communication I/F unit 31 is configured to communicate with the on-vehicle device 3 of the vehicle 2 and the portable terminal 40 through the network 5.

The storage unit 32 can include, for example, a read only memory (ROM) or a random access memory (RAM). The storage unit 32 stores various programs used for pieces of processing by the controller 33 and various pieces of data (for example, map information, various parameters, and various threshold values).

The controller 33 can be, for example, a processor having a CPU and peripheral circuits thereof. The controller 33 executes various programs stored in the storage unit 32 and thus can execute various controls of the server 30. The controller 33 executes processing related to the server 30 among the pieces of passenger transportation processing related to the mobility service described below with reference to FIG. 5.

Further, the controller 33 includes a plurality of functional modules implemented by the program executed on the processor of the controller 33. As shown in FIG. 3, in the embodiment, the controller 33 includes an acquisition unit 34, a getting on and off position setting unit 35, a vehicle search unit 36, an allocated vehicle selection unit 37, and a getting on and off position transmission unit 38, as functional modules.

The acquisition unit 34 acquires a kind of user from the portable terminal 40. The getting on and off position setting unit 35 sets a getting on position or a getting off position of the user 4. The vehicle search unit 36 searches for a vehicle 2 whose operation plan can be adjusted such that the vehicle stops at the getting on position set by the getting on and off position setting unit 35. The allocated vehicle selection unit 37 selects a vehicle 2 suitable for the transportation of the user 4 from the vehicle 2 searched by the vehicle search unit 36. The getting on and off position transmission unit 38 transmits the set getting on position or the set getting off position of the user 4 to the on-vehicle device 3 of the vehicle 2 selected by the allocated vehicle selection unit 37.

Configuration of Portable Terminal

FIG. 4 is a schematic configuration diagram of the portable terminal 40 according to the embodiment. The portable terminal 40 includes a user I/F unit 41, a communication I/F unit 42, a positioning sensor 43, a storage unit 44, and a controller 45. The portable terminal 40 is owned by the user 4 and is movable with the user 4.

The user I/F unit 41 has, for example, a touch panel display. The user I/F unit 41 generates a signal in response to an operation (for example, activation of an application related to the mobility service or whether to approve ridesharing with another passenger) by the user of the portable terminal 40 and outputs the signal to the controller 45. Further, the user I/F unit 41 displays various pieces of display information (for example, a message for proposing ridesharing with another passenger, information for specifying the vehicle such as a license plate of a vehicle to get on, a meeting place, and a meeting timepoint) received from the controller 45.

The communication I/F unit 42 is an example of the communication unit and is a communication I/F circuit for connecting the portable terminal 40 to the network 5. The communication I/F unit 42 is configured to be able to communicate with the on-vehicle device 3 of the vehicle 2 and the server 30 through the network 5.

The positioning sensor 43 generates position information indicating a current location of the portable terminal 40 and outputs the position information to the controller 45. The positioning sensor 43 is, for example, a GPS. The positioning sensor 43 generates position information indicating a current location of the portable terminal 40 and outputs the position information to the controller 45.

The storage unit 44 can include, for example, a read only memory (ROM) or a random access memory (RAM). The storage unit 44 stores various programs used for pieces of processing by the controller 45 and various pieces of data (for example, various parameters and various threshold values).

The controller 45 can be, for example, a processor having a CPU and peripheral circuits thereof. The controller 45 executes various programs stored in the storage unit 44 and thus can execute various controls of the portable terminal 40. The controller 45 executes processing related to the portable terminal 40 among the pieces of passenger transportation processing related to the mobility service described below with reference to FIG. 5.

Overview of Passenger Transportation Processing

FIG. 5 is a sequence diagram showing an example of the passenger transportation processing related to the mobility service in the passenger transportation system 1 according to the embodiment. In the sequence diagram shown in FIG. 5, the communication between the server 30 and the on-vehicle device 3 of the vehicle 2 and the portable terminal 40 is performed through the network 5.

A user who uses the mobility service registers user information and the like in advance using the portable terminal 40 and the like. The registered user information is stored in the storage unit 32 of the server 30 for each user. When the user requests the use of the mobility service, that is, requests an arrangement of the vehicle 2, the user operates the portable terminal 40 to input request information to the portable terminal 40. The input of the request information is performed, for example, on the application for mobility service installed in the portable terminal 40.

In step S1, the portable terminal 40 carried by the user 4 who intends to use the mobility service transmits the request information to the server 30. The request information includes, for example, a current location of the user, a destination of the user, identification information of the user for example, the registration number of the user), fellow passenger information (the number of people to get on, and the like), and availability of ridesharing with another person. Further, the current location and the destination of the user 4 are designated by, for example, a facility name, an address, or a combination of longitude and latitude. The request information may include a desired getting on position of the user 4 instead of including the current location of the user 4.

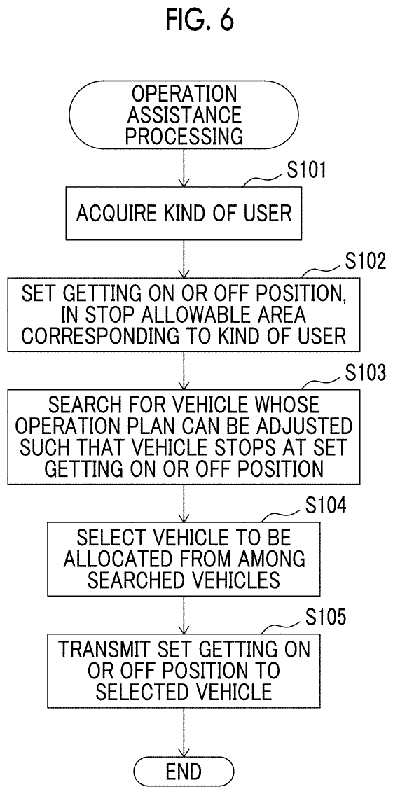

When the server 30 receives the request information from the user 4 through the portable terminal 40, the server 30 selects a vehicle 2 suitable for the transportation of the user 4 and creates an operation plan for transporting the user 4 in step S2. A method of selecting the vehicle 2 will be described below with reference to FIG. 6. When the user 4 permits the ridesharing with another person, a vehicle 2 being used by another user may be selected. Further, the operation plan created in step S2 includes a getting on position where the, user 4 gets on the vehicle 2, a getting of (position where the user 4 gets off the vehicle 2, a scheduled arrival time to the getting on position, a traveling route to the getting off position, a scheduled arrival time to the getting off position, and the like.

In step S3, the server 30 transmits the vehicle allocation information to the portable terminal 40. The vehicle allocation information transmitted to the portable terminal 40 includes the getting on position, the getting off position, the scheduled arrival time to the getting on position, the traveling route to the getting off position, the scheduled arrival time to the getting off position, identification information of the vehicle 2 (a number of a license plate, a vehicle kind, a color, and the like), presence or absence of ridesharing with another person, and the like. Further, in step S4, the server 30 transmits the vehicle allocation information to the vehicle 2. The vehicle allocation information transmitted to the vehicle 2 includes the getting on position, the getting oil position, the traveling route to the getting off position, the identification information of the user, and the like.

In step S5, when the on-vehicle device 3 of the vehicle 2 receives the vehicle allocation information from the server 30, an autonomous driving, control is performed on the vehicle 2 to start to move the vehicle 2 to the getting on position. Thereafter, in step S6, the vehicle 2 arrives at the getting on position and the vehicle 2 stops.

When the user 4 gets on the allocated vehicle 2 and, for example, causes the portable terminal 40 to perform near-field wireless communication with the getting on and off detector 56, the on-vehicle device 3 of the vehicle 2 detects and notifies the server 30 that the user 4 gets on the vehicle 2 based on the detection signal output from the getting on and off detector 56 in step S7. The getting on notification is used, for example, when the server 30 creates next and subsequent operation plans for the vehicle 2. The user 4 may operate the portable terminal 40 to notify the server 30 that the user 4 gets on the vehicle 2 instead of the on-vehicle device 3 of the vehicle 2 notifying the server 30 that the user 4 gets on the vehicle 2.

In step S8, the on-vehicle device 3 of the vehicle 2 performs the autonomous driving control on the vehicle 2 to start to move the vehicle 2 to the getting off position. While the vehicle 2 moves to the getting off position, the on-vehicle device 3 of the vehicle 2 periodically transmits, for example, the position information indicating the current location to the server 30. Thereafter, in step S9, the vehicle 2 arrives at the getting off position, and the vehicle 2 stops.

When the user 4 gets off the vehicle 2 and, for example, causes the portable terminal 40 to perform near-field wireless communication with the getting on and off detector 56, the on-vehicle device 3 of the vehicle 2 detects and notifies the server 30 that the user 4 gets off the vehicle 2 based on the detection signal output from the getting on and off detector 56 in step S10. This getting off notification is used, for example, when the server 30 creates next and subsequent operation plans for the vehicle 2, similar to the above getting on notification. The user 4 may operate the portable terminal 40 to notify the server 30 that the user 4 gets off the vehicle 2 instead of the on-vehicle device 3 of the vehicle 2 notifying the server 30 that the user 4 gets off the vehicle 2.

When a series of services as described above ends, the vehicle 2 is in a standby state for transporting a next user or moves to a getting on position of the next user.

Problem

Incidentally, in such an autonomous driving technique, the getting on and off position designated by the user 4 may not always be appropriate for the user 4 to get on and off. For example, the welfare vehicle configured to support a wheelchair user or the like to get on and off the vehicle needs a large space for getting on and off the wheelchair, such as a space for extending the deck out of the vehicle and a space for forming the slopes for the wheelchair. Therefore, there may a case where there is not enough space for getting on and off the wheelchair depending on the getting on and off position designated by the user and thus the wheelchair user or the like cannot safely get on and off.

Further, for example, when a child alone uses such a mobility service, it may be preferable to get the child on and off at a place where the number of car passes is relatively smaller than the designated getting on and off position from a viewpoint of restraining a traffic accident or the like.

Furthermore, in the above autonomous driving vehicle, there is no occupant such as a driver unlike a taxi or the like in the related art. Therefore, it is difficult to change a getting on and off position even when the getting on, and off position designated by the user is not a place suitable for getting on and off.

Getting On and Off in Stop Allowable Area Corresponding to Kind of User

In the embodiment, a stop allowable area for getting on and off is set in advance for each kind of user, and the getting on and off position setting unit 35 sets the getting on position or the getting off position of the user 4 in the stop allowable area corresponding to the kind of the user acquired by the acquisition unit 34. Thereby according to the embodiment, it is possible to restrain the user 4 from getting on and off at an inappropriate place. Hereinafter, the operation assistance device according to the embodiment will be described in detail.

Operation Assistance Processing

FIG. 6 is a flowchart showing a control routine of operation assistance processing in the operation assistance device according to the embodiment. The flow of the control routine is realized by the processor of the controller 33 of the server 30 executing the program stored in the storage unit 32 of the server 30. The control routine is executed, for example, by the controller 33 of the server 30 after step S1 described above in FIG. 5, that is, when the server 30 receives the request information from the portable terminal 40. Specifically, the following steps S101 to S104 are executed during step S2 in FIG. 5, and the following step S105 is executed during step S4 in FIG. 5.

In step S101, the acquisition unit 34 of the server 30 acquires the kind of the user who uses the mobility service. The kind of the user can be, for example, a wheelchair user, a stroller user, a child, a visually impaired person, an injured person, a pregnant woman, an elderly person, a pet companion, a user who carries large luggage, and the like. The acquisition unit 34 of the server 30 may acquire a plurality of kinds of the user from these kinds of the user.

The kind of user is included, for exam, in the request information transmitted from the portable terminal 40 in step S1 of FIG. 1. When the server 30 receives the request information, the storage unit 32 of the server 30 stores the kind of the user in the request information association with the user. The acquisition unit 34 acquires, for example, the kind of the user from the storage unit 32.

The portable terminal 40 can transmit the request information including the kind of the user, for example, as follows. That is, for example, when the user 4 inputs the request information in the portable terminal 40, the portable terminal 40 displays a plurality of items indicating the kind of the user. The user 4 selects and input; an item corresponding to the user 4 among the items displayed on the portable terminal 40 using the portable terminal 40. Accordingly, the portable terminal 40 can transmit the request information including the selected kind of the user to the server 30.

Further, the kind of the user may be registered in advance by each user and stored the storage unit 32 of the server 30 as user information on the user 4. In this case, the request information transmitted from the portable terminal 40 in step S1 of FIG. 1 may not include the kind of user. In this case, the acquisition unit 34 can also acquire for example, the kind of the user from the storage unit 32.

Next, in step S102, the getting on and off position setting unit 35 sets the getting on position or the, getting off position of the user 4 in the stop allowable area corresponding to the kind of the user acquired by the acquisition unit 34. For example the getting on and off position setting unit 35 sets a position closest to the current location of the user 4 in the stop allowable area corresponding to the kind of the acquired user as the getting on position and sets a position closest to the destination of the user 4 as the getting off position. When the request information includes the desired getting on position of the user 4, the getting on and off position setting unit 35 may set a position closest to the desired getting on position as the getting on position.

In the embodiment, the stop allowable area for getting on and off is set in advance for each kind of the user. For example, the storage unit 32 of the server 30 stores these stop allowable areas in association with the map information for each kind of user. For example, the stop allowable area when the kind of user is a wheelchair user is a wheelchair dedicated space in a parking lot, a station rotary a taxi stop, a coin parking, and the like. Further, for example, the stop allowable area when the kind of the user is a child is a road other than a road where there are a relatively large number of predetermined car passes, a parking lot, and the like. Further, for example, the stop allowable area when the kind of the user is a visually impaired person is an area near a place where a Braille block or a voice guidance apparatus is provided, in a road other than a road where there are a relatively large number of predetermined car passes, a parking lot, and the like.

When the acquisition unit 34 of the server 30 acquires the kinds of the user in step S101, the getting on and off position setting unit 35 may set the getting on position or the getting off position based on an overlapping area in each stop allowable area in the kinds of the user. Further, for example, when a priority for the kind of the user is set in advance and there is no overlapping area for each stop allowable area in a predetermined range from the current location or the destination of the user 4, the getting on and off position setting unit 35 may set the getting on position or the getting off position based on a stop allowable area for a kind of user with the highest priority.

Next, in step S103, the vehicle search unit 36 searches for a vehicle 2 whose operation plan can be adjusted such that the vehicle stops at the getting on position set by the getting on and off position setting unit 35. Specifically, the vehicle search unit 36 searches for, for example, a vehicle that travels in a predetermined range from the getting on position set by the getting on and off position setting unit 35 in a predetermined time after the server 30 receives the request information from the portable terminal 40, based on the operation plan of each vehicle 2. The vehicle search unit 36 may search for a vehicle 2 whose operation plan can be adjusted such that the vehicle stops at, for example, the current location of the user or the desired getting on position instead of the getting on position set by the getting on and off position setting unit 35. In this case, step S103 may be executed before step S101 or S102.

Next, in step S104, the allocated vehicle selection unit 37 selects a vehicle 2 suitable for transporting the user 4 from the vehicle searched by the vehicle search unit 36. For example, the allocated vehicle selection unit 37 can select the vehicle 2 closest to the getting on position set by the getting on and of position setting unit 35 among the vehicles 2 searched by the vehicle search unit 36 as the vehicle 2 to be allocated to the getting on position.

Next, in step S105 the getting on and of position transmission unit 38 transmits the getting on position or the getting off position set by the getting on and off position setting unit 35 to the on-vehicle device 3 of the vehicle 2 selected by the allocated vehicle selection unit 37. The set getting on position or the set getting off position is included in the allocation information transmitted to the vehicle 2. When the on-vehicle device 3 of the vehicle 2 receives the allocation information including the set getting on position or the set getting off position, the autonomous driving controller 24 of the ECU 20 controls the traveling of the vehicle 2 so as to head toward the getting on position or the getting off position. After step S103, the control routine ends.

When the getting on and off position setting unit 35 sets the getting on position or the getting off position at a position different from the current location or the destination of the user 4 in step S102, the server 30 may transmit the set getting on position or the set getting off position and an inquiry whether the getting on and off at the set getting on position or the set getting off position is available to the portable terminal 40 before step S103. When the user 4 inputs an answer whether the getting on and off at the set getting on position or the set getting off position is available, the portable terminal 40 transmits the answer to the server 30. When the server 30 receives, from the portable terminal 40, an answer that the getting on and off at the set getting on position or the set getting off position is available, the set getting on position or the set getting off position may be used in steps after step S103. On the other hand, when the server 30 receives, from the portable terminal 40, an answer that the getting on and off at the set getting on position or the set getting off position is not available, the current location or destination of the user 4 may be used in steps after step S103 instead of the set getting on position or the set getting off position.

### Second Embodiment

Next, an operation assistance device according to a second embodiment will be described. The configuration of the operation assistance device of a vehicle according to the second embodiment is basically the same as the configuration of the operation assistance device of the vehicle according to the first embodiment. Hereinafter, portions different from the configuration of the operation assistance device of the vehicle according to the first embodiment will be mainly described.

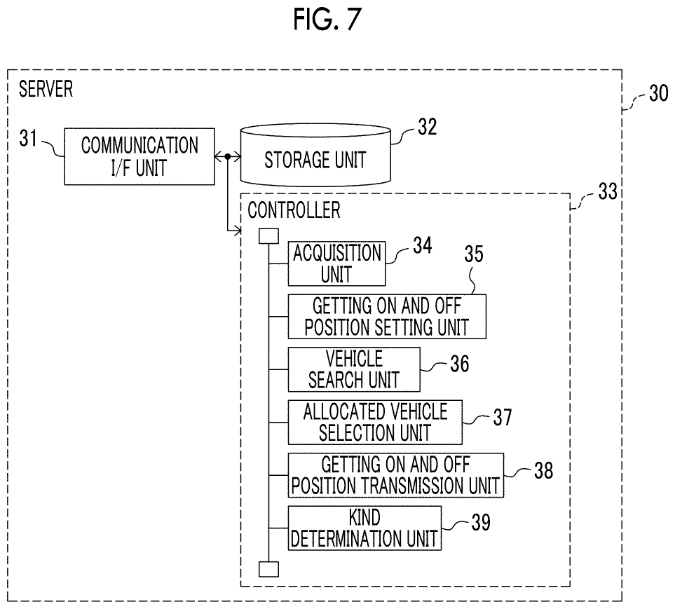

FIG. 7 is a schematic configuration diagram of the server 30 according to the embodiment. As shown in FIG. 7, the controller 33 of the server 30 further includes a kind determination unit 39 as the functional module in addition to the acquisition unit 34, the getting on and off position setting unit 35, the vehicle search unit 36, the allocated vehicle selection unit 37, and the getting on and off position transmission unit 38.

In the embodiment, when the kind determination unit 39 determines that the kind of the user acquired by the acquisition unit 34 is a specific kind, the vehicle search unit 36 searches for a vehicle 2 whose operation plan can be adjusted such that the vehicle stops at the gelling on position set by the getting on and off position setting unit 35 in a state where a passenger gets on. The allocated vehicle selection unit 37 selects a vehicle 2 to be allocated to the getting on position from among the searched vehicles while the passenger gets on. Thereby, for example, when a mobility service that uses an autonomous driving vehicle without a driver getting on together is used, a wheelchair user or the like can use such a mobility service while obtaining a sense of security that there is a fellow passenger Hereinafter, the embodiment will be described in detail.

Operation Assistance Processing

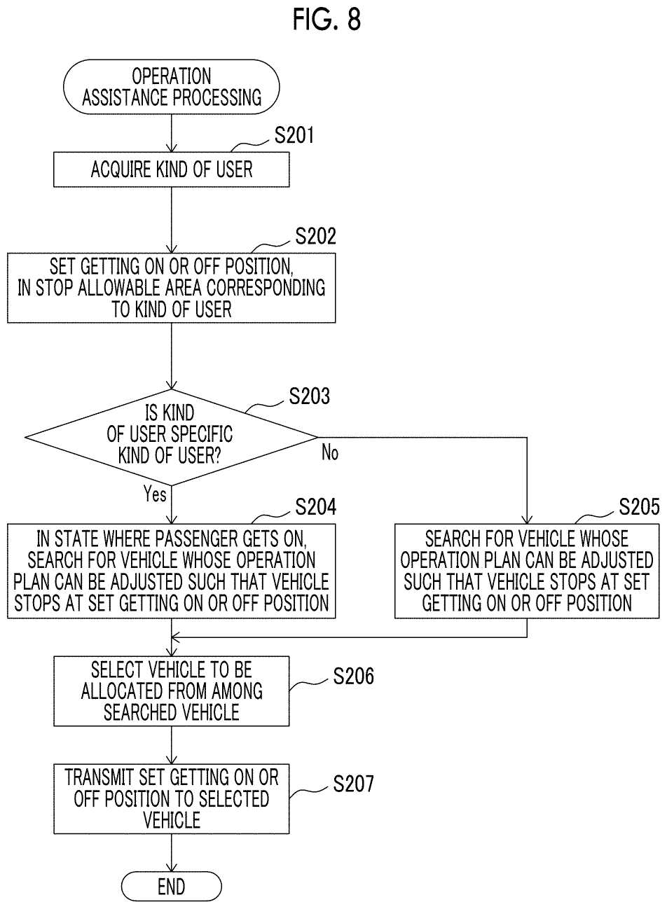

FIG. 8 is a flowchart showing a control routine of operation assistance processing in the operation assistance device according to the embodiment. The flow of the control routine is realized by the processor of the controller 33 of the server 30 executing the program stored in the storage unit 32 of the server 30. Since steps S201, S202, and S205 to S207 in FIG. 8 arc respectively the same as steps S101 to S105 in FIG. 6, the descriptions of these steps are omitted.

In step S203, the kind determination unit 39 determines whether the kind of the user acquired by the acquisition unit 34 is a specific kind. For example, in step S203, the kind determination unit 39 determines whether the user is a specific kind of the user who needs supporting in getting on and off the vehicle 2 such as a wheelchair user based on the kind of the user acquired by the acquisition unit 34.

When determination is made that the kind of user is the specific kind in step S203, the control routine proceeds to step S204. On the other hand, when determination is made that the kind of user is not the specific kind in step S203, the control routine proceeds to step S205 and then proceeds to step S206.

In step S204, the vehicle search unit 36 searches for a vehicle whose operation plan can be adjusted such that the vehicle stops at the getting on position set by the getting on and off position setting unit 35 in a state where a passenger gets on. Specifically, the vehicle search unit 36 searches for, for example, a vehicle that travels in a predetermined range from the getting on position set by the getting on and off position setting unit 35 in a state where a passenger gets on in a predetermined time after the server 30 receives the request information from the portable terminal 30, based on the operation plan of each vehicle 2. Thereafter, the control routine proceeds to step S206.

In the embodiment, in step S204, the vehicle search unit 36 searches for a vehicle whose operation plan can be adjusted such that the vehicle stops at the getting on position set by the getting on and off position setting unit 35 in a state where a passenger gets on. The present disclosure is not limited thereto, and the vehicle search unit 36 was further search for a vehicle whose operation plan can be adjusted such that the vehicle stops art the set getting on position in a state where a passenger who accepts supporting another user to get on, based on support availability information indicating whether or not supporting another user to get on the vehicle 2 together is available. Thereby, for example, a wheelchair user or the like can use the mobility service while obtaining a sense of security that there is a fellow passenger who can provide supporting such as getting on and off.

Such support availability information is, for example, included in the request information. When the server 30 receives the request information, the storage unit 32 of the server 30 stores the support availability information in the request information in association with the user.

The portable terminal 40 can transmit thee request information including the support availability information, for example, as follows. That is, for example, when the user 4 inputs the, request information m the portable terminal 40, the portable terminal 40 displays a check item for selecting availability of supporting another user to get on the vehicle 2 together. The user 4 uses the portable terminal 40 to select and input the availability in the check item displayed on the portable terminal 40. Thereby, the portable terminal 40 can transmit the request information including the support availability information to the server 30.

Further, the support availability information may be registered in advance by each user and stored in the storage unit 32 of the server 30 as user information on the user 4, similar to the kind of the user. In this case, the request information may not include the support availability information, and the vehicle search unit 36 may search for the vehicle 2 using, for example, the support availability information on the user stored in the storage unit 32.

Further, when the allocated vehicle selection unit 37 selects the vehicle 2 searched by the vehicle search unit 36 based on the support availability information as a vehicle for a user of the specific kind described above to get on, the server 30 may transmit in advance a notification dial a user 4 of such a specific kind gets on and off to the portable terminal 40 of another user 4 who accepts the supporting in the vehicle 2 before the user 4 of the specific kind gets on and off. Thereby, when the user 4 of such a specific kind gets on and off, it is possible for another user 4 who accepts the supporting to quickly respond.

### Third Embodiment

Next, an on-vehicle device 3 according to a third embodiment will be described. The configuration of the on-vehicle device 3 according to the third embodiment is basically the same as the configuration of the on-vehicle device 3 according to the first embodiment. Hereinafter, portions different from the configuration of the on-vehicle device 3 according to the first embodiment will be mainly described.

In the above embodiment, the server 30 sets the getting on position or the getting off position of the user 4. However, in the embodiment, the on-vehicle device 3 of the vehicle 2 sets the getting on position or the getting off position of the user 4.

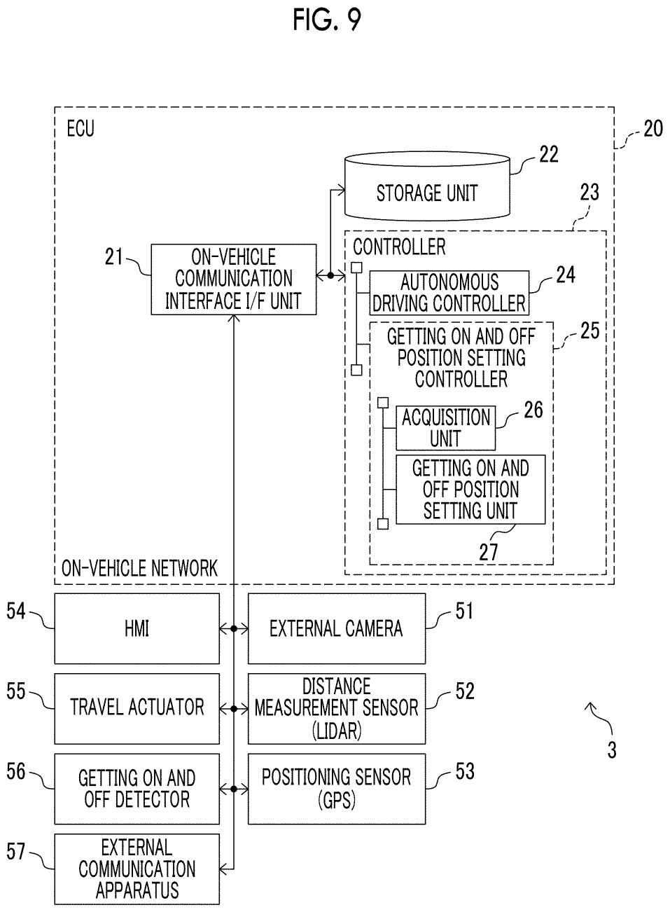

FIG. 9 is a schematic configuration diagram of the on-vehicle device 3 of the vehicle 2 according to the embodiment. As shown in FIG. 9, the controller 23 of die ECU 20 includes a getting on and off position setting controller 25 that executes processing in the getting on and off position setting control according to the embodiment as the functional modules in addition to the autonomous driving controller 24. The getting on and off position setting controller 25 includes an acquisition unit 26 and a getting on and off position setting unit 27.

Further, in the above embodiment, the controller 33 of the server 30 includes the acquisition unit 34, the getting on and off position setting unit 35, and the getting on and off position transmission unit 36. However, in the embodiment, the controller 33 of die server 30 does not have these functional modules.

Sequence Diagram

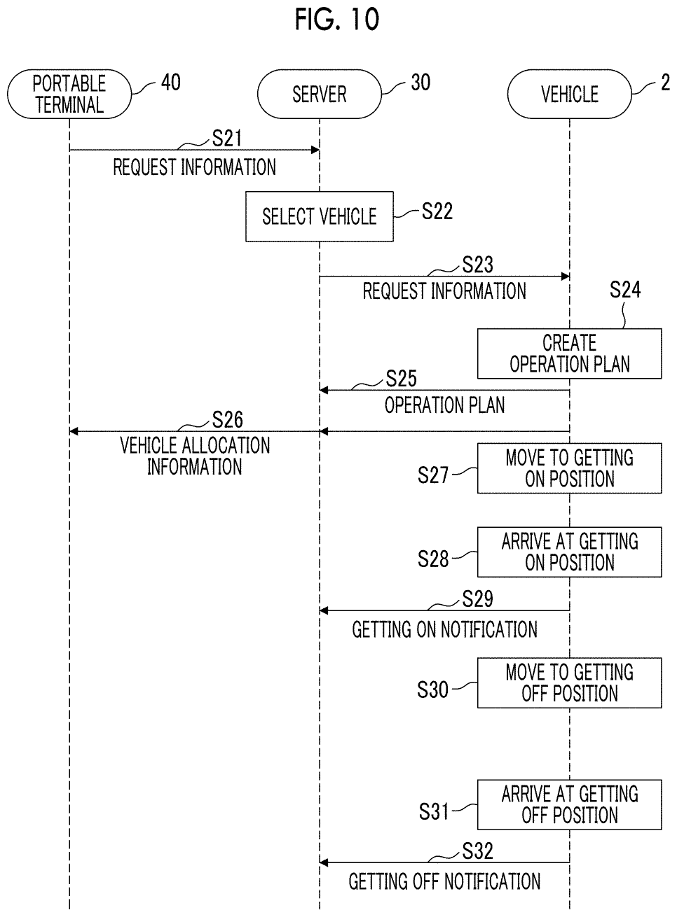

FIG. 10 is a sequence diagram showing an example of the passenger transportation processing related to the mobility service in the passenger transportation system 1 according to the embodiment. Since steps S21 and S27 to S32 in FIG. 10 are respectively the same as steps S1 and S5 to S10 in FIG. 5, the descriptions of these steps are omitted.

In step S22, the server 30 selects a vehicle 2 suitable for the transportation of the user 4. Here, the vehicle search unit 36 of the server 30 searches, for example, a vehicle 2 whose operation plan can be adjusted such that the vehicle stops at a current location of the user 4. Further, the allocated vehicle selection unit 37 of the server 30 selects, for example, a vehicle 2 closest to the current location of the user 4 from among the vehicles searched by the vehicle search unit 36 as a vehicle 2 to be allocated to the getting on position.

In step S23, the server 30 transmits the request information to the selected vehicle 2. Similar to step S21, the request information includes, for example, the current location of the user, the destination of the user, the identification information of the user, the fellow passenger information, the availability of ridesharing with another person, and the like.

Instep S24, the on-vehicle device 3 of the vehicle 2 creates an operation plan for transporting the user 4. The operation plan includes the getting on position, the getting off position, the scheduled arrival time at the getting on position, the traveling route to the getting off position, the scheduled arrival time at the getting off position, and the like. In step S25, the on-vehicle device 3 of the vehicle 2 transmits the created operation plan to the server 30.

In step S26, the on-vehicle device 3 of the vehicle 2 transmits the vehicle allocation information to the portable terminal 40 through the server 30. In this embodiment, the vehicle allocation information includes the getting on position, the getting off position, the scheduled arrival time at the getting on position, the traveling route to the getting off position, the scheduled arrival time for the getting off position, the identification information of the vehicle 2, the presence or absence of ridesharing with another person, and the like.

Operation Assistance Processing

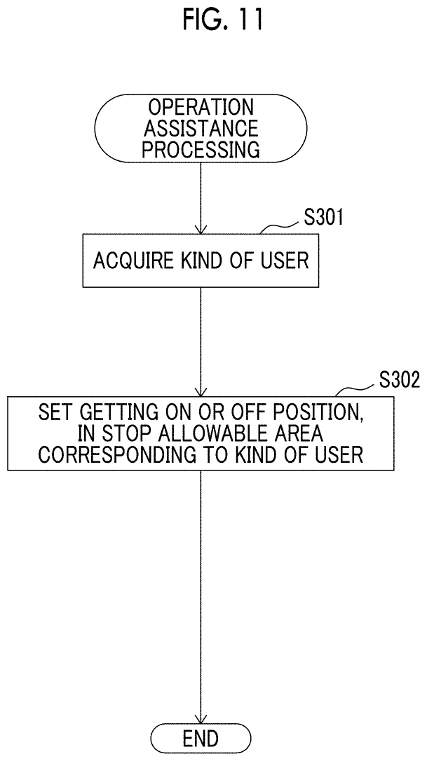

FIG. 11 is a flowchart showing a control routine of operation assistance processing, in the operation assistance device according to the embodiment. The flow of the control routine is realized by the processor of the controller 23 of the on-vehicle device 3 executing a program stored in the storage unit 22 of the on-vehicle device 3. The control routine is executed, for example, by the controller 23 of the on-vehicle device 3 after step S23 in FIG. 10, that is, when the on-vehicle device 3 receives the request information from the server 30.

In step S301 the acquisition unit 26 of the ECU 20 acquires the kind of user. The kind of user is included in the request information transmitted from the server 30.

Next, in step S302, the getting on and off position setting unit 27 of the ECU 20 sets the getting on position or the getting off position of the user 4 in the stop allowable area corresponding to the kind of the user acquired by the acquisition unit 26.

After step S302, the control routine ends. When the getting on position or the getting off position is set in step S302, the autonomous driving controller 24 of the ECU 20 controls the trawling of the vehicle 2 so as to head toward the getting an position or the getting off position.

### Fourth Embodiment

Next, an operation assistance device according to a fourth embodiment will be described. The configuration of the operation assistance device according to the fourth embodiment is basically the same as the configuration of the operation assistance device according to the first embodiment. Hereinafter, portions different from the configuration of the operation assistance device according to the first embodiment will be mainly described.

In the above embodiment, the unmanned autonomous driving vehicle is used as the vehicle 2. However, in the embodiment, a manned driving vehicle in which a driver drives the vehicle 2 is used as the vehicle 2.

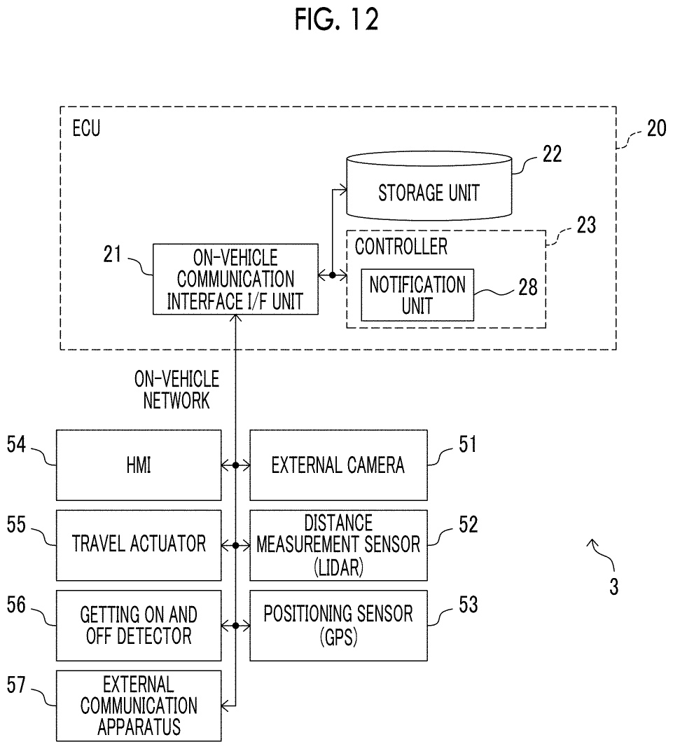

FIG. 12 is a schematic diagram of the configuration of the on-vehicle device 3 of the vehicle 2 according to the embodiment. As shown in FIG. 12, the ECU 20 of the vehicle 2 includes a notification unit 28 while not having the autonomous driving controller 24.

In the embodiment, when the on-vehicle device 3 receives the getting on position or the getting off position set in the getting on and off position setting unit 35 from the getting on and off position transmission unit 36 of the server 30, the notification unit 28 notifies the driver of the vehicle 2 of the set getting on position or the set getting off position through the HMI 54. For example, the notification unit 28 displays map information indicating the set getting on position or the set getting off position on the HMI 54 provided in a seat of the driver. Thereby, the driver of the vehicle 2 can drive the vehicle 2 toward the set getting on position or the getting off position. The notification unit 28 may display map information indicating the stop allowable area on the HMI 54 in addition to the getting on position or the getting off position.

In the embodiment, the on-vehicle device 3 performs the notification of the getting on position or the getting off position using the getting on position or the getting off position received from the server 30. However, the getting on position or the getting off position may be notified using the getting on position or the getting off position set in the getting on and, off position setting unit 27 of the on-vehicle device 3 as in the third embodiment.

1. An operation assistance device that assists an operation of a vehicle, the operation assistance device comprising:
a communication unit configured to communicate with a portable terminal of a user who uses the vehicle and an on-vehicle device mounted on the vehicle;
an acquisition unit configured to acquire a kind of the user from the portable terminal through the communication unit;
a getting on and off position setting unit configured to set a getting on position or a getting off position of the user; and
a getting on and off position transmission unit configured to transmit the set getting on position or the set getting off position to the on-vehicle device through the communication unit, wherein:
a stop allowable area for getting on and off is set in advance for each kind of the user; and
the getting on and off position setting unit sets the getting on position or the getting off position in the stop allowable area corresponding to the acquired kind of the user.

2. The operation assistance device according to claim 1, wherein:
the on-vehicle device includes an autonomous driving controller configured to cause the vehicle to perform autonomous traveling; and
the autonomous driving controller is configured to cause the vehicle to travel toward the getting on position or the getting off position transmitted through the getting on and off position transmission unit.

3. The operation assistance device according to claim 2, further comprising:
a vehicle search unit configured to search for a vehicle whose operation plan is adjustable such that the vehicle stops at the set getting on position in a state where another passenger gets on when the kind of the user is a specific kind; and
an allocated vehicle selection unit configured to select a vehicle to be allocated to the getting on position from among the searched vehicles,
wherein the getting on and off position transmission unit transmits the set getting on position or the set getting off position to an on-vehicle device of the selected vehicle through the communication unit.

4. The operation assistance device according to claim 3, wherein:
the acquisition unit acquires support availability information indicating whether or not supporting another user to get on the vehicle together is available from the portable terminal through the communication unit; and
the vehicle search unit searches for a vehicle whose operation plan is adjustable such that the vehicle stops at the set getting on position in a state where another passenger who accepts the supporting another user gets on based on the acquired support availability information.

5. An on-vehicle device mounted on a vehicle, the on-vehicle device comprising:
a communication unit configured to communicate with a portable terminal of a user who uses the vehicle;
an acquisition unit configured to acquire a kind of the user from the portable terminal through the communication unit; and
a getting on and off position setting unit configured to set a getting on position or a getting off position of the user, wherein:
a stop allowable area for getting on and off is set in advance for each kind of the user; and
the getting on and off position setting unit sets the getting on position or the getting off position in the stop allowable area corresponding to the acquired kind of the user.

6. The on-vehicle device according to claim 5, further comprising an autonomous driving controller configured to cause the vehicle to perform autonomous traveling,
wherein the autonomous driving controller is configured to cause the vehicle to travel toward the set getting on position or the set getting off position.

7. An operation assistance system that assists an operation of a vehicle, the system comprising:
a portable terminal of a user who uses the vehicle;
an on-vehicle device mounted on the vehicle and configured to communicate with the portable terminal; and
a server configured to communicate with the portable terminal and the on-vehicle device, wherein:
the server includes
an acquisition unit configured to acquire a kind of the user from the portable terminal,
a getting on and off position setting unit configured to set a getting on position or a getting off position of the user, and
a getting on and off position transmission unit configured to transmit the set getting on position or the set getting off position to the on-vehicle device;
a stop allowable area for getting on and off is set in advance for each kind of the user; and
the getting on and off position setting unit sets the getting on position or the getting off position in the stop allowable area corresponding to the acquired kind of the user.

8. An operation assistance system that assists an operation of a vehicle, the system comprising:
a portable terminal of a user who uses the vehicle; and
an on-vehicle device mounted on the vehicle and configured to communicate with the portable terminal, wherein:
the on-vehicle device includes
an acquisition unit configured to acquire a kind of the user from the portable terminal, and
a getting on and off position setting unit configured to set a getting on position or a getting off position of the user;
a stop allowable area for getting on and off is set in advance for each kind of the user; and
the getting on and off position setting unit sets the getting on position or the getting off position in the stop allowable area corresponding to the acquired kind of the user.

9. An operation assistance method that assists an operation of a vehicle, the method comprising:
a step of acquiring a kind of the user from a portable terminal of a user who uses the vehicle; and
a step of setting a getting on position or a getting off position of the user, wherein:
a stop allowable area for getting on and off is set in advance for each kind of the user; and
the step of setting sets the getting on position or the getting off position in the stop allowable area corresponding to the acquired kind of the user.

10. An operation assistance program that assists an operation of a vehicle, the program causing a processor to execute:
a step of acquiring a kind of the user from a portable terminal of a user who uses the vehicle; and
a step of setting a getting on position or a getting off position of the user, wherein:
a stop allowable area for getting on and off is set in advance for each kind of the user; and
the step of setting sets the getting on position or the getting off position in the stop allowable area corresponding to the acquired kind of the user.
